(19) United States
(12) Patent Application Publication
(10) Pub. No.: US 2007/0126951 A1
(43) Pub. Date: Jun. 7, 2007

(54) Method of producing an electro-optic device and electro-optic device

(75) Inventors: Joost P.A. Vogels, Leende (NL); Dirk J. Broer, Geldrop (NL); Hjalmar E.A. Huitema, Veldhoven (NL); Roel Penterman, Eindhoven (NL); Stephen I. Klink, Breda (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,670

(22) PCT Filed: Dec. 17, 2004
(86) PCT No.: PCT/IB04/52845

§ 371 Date: Jun. 21, 2006

(30) Foreign Application Priority Data
Dec. 27, 2003 (GB) 0330075.3

(51) Int. Cl. G02F 1/1333

(52) U.S. Cl. 349/86

(57) ABSTRACT

The present invention discloses an electronic device (100) comprising a substrate (10) carrying an electrode structure (12); an electro-optical stack (90) at least partially covering the electrode structure (12), the electro-optical stack comprising a stratified polymer layer (44), a further substrate (20) and an electro-optical material (32) sandwiched between the polymer layer (44) and the further substrate (20); and an adhesive layer (60) between the substrate (10) and the electro-optical stack, as well as a method for producing such an electronic device (100), in which the electro-optical stack (90) and the substrate (10) are prepared in separate processes and combined by an adhesive layer (60). This improves the yield of such an electronic device (100), because a production error in one of the components no longer leads to the loss of the whole electronic device (100). Also, sensitive components on the substrate (10) such as polymer based TFTs, are protected from exposure to the processing steps of the electro-optical stack (90).

The present invention relates to a method of producing an electronic device having a stratified electro-optical stack on a substrate carrying an electrode structure.

The present invention also relates to an electronic device having a stratified electro-optical stack on a substrate carrying an electrode structure.

Nowadays, electronic devices having electro-optical elements, such as liquid crystal displays (LCDs) and electrophoretic display devices such as E-Ink devices attract a lot of attention for various reasons. In the case of LCDs, the flatness of the display device makes LCDs an attractive alternative to the more bulky cathode ray tube (CRT) displays and the more expensive plasma displays. Traditionally, the optical stack of LCDs has been formed by filling a cavity between two substrates, which typically are pre-treated glass plates, with an appropriate liquid crystal material. However, this has the disadvantage that, especially for larger size displays, the handling of the substrates becomes very difficult due to the weight of the substrates, and filling the cavity becomes time-consuming. At least some of these problems can be avoided by forming the optical stack in an alternative way. In European patent application EP1065553, a method is described in which a mixture of a liquid crystal material and a polymer precursor is applied to an active matrix substrate. A polymer topcoat is formed in a so-called stratification process from a fraction of the polymer precursor in a first UV exposure step, after which polymer sidewalls are formed from the remaining polymer precursor in a UV exposure step using a mask to form the various pixels of the LCD.

In non-prepublised UK patent application UK 0319908.0 with priority date 23 Aug. 2003, separate droplets of a mixture of an electro-optical material and a polymer precursor are deposited over a substrate, after which the electro-optical elements are formed by exposing the various droplets to a stimulus such as UV light to form a polymer layer, by means of a stratification process, that encapsulates the electro-optical material between the substrate and said polymer layer.

One of the advantages of these two techniques is that an LCD, or an electronic device utilizing an electro-optical material, can be formed on a single substrate, using lightweight materials, thus yielding a lighter device that is easier to handle than the prior art devices having two substrates.

In addition, the stratification steps, in which the polymer materials are formed, can be performed at relatively low temperatures, which facilitates the application of the technique on substrates carrying temperature-sensitive materials, e.g., organic semi-conductor materials in organic based thin film transistors (TFTs) of an active matrix backplane. The use of organic materials is of particular interest, because they facilitate the formation of flexible backplanes, which, in combination with a stratified optical stack, can be used to form a flexible display device.

However, one of the problems that may occur when depositing the mixture of the electro-optical material and the polymer precursor on such an active matrix backplane is the sensitivity of the components on the active matrix (AM) backplane to chemicals used in the processing steps of forming the optical stack. For instance, in the case of optical stack comprising a liquid crystal (LC) material, an alignment layer for the LC material has to be deposited on the AM backplane. Typically, this is done by deposition of the alignment material in a dissolved form, after which the solvent is evaporated. However, the solvent used in this process can damage the organic semiconductor materials on the AM backplane.

The present invention seeks to provide a method for producing an electronic device having a stratified electro-optical stack on a substrate carrying an electrode structure that at least partially obviates this problem.

The present invention further seeks to provide an improved electronic device having a stratified electro-optical stack on a substrate carrying an electrode structure.

According to an aspect of the invention, there is provided a method of producing an electronic device having a stratified electro-optical stack on a substrate carrying an electrode structure, the method comprising the steps of: providing the substrate carrying the electrode structure; providing a further substrate; depositing a mixture of a electro-optical material and a polymer precursor on the further substrate; forming the stratified electro-optical stack by polymerizing the polymer precursor into a polymer layer sandwiching the electro-optical material between the polymer layer and the further substrate; and adhering the substrate to the stratified electro-optical stack.

The present invention is based on the realisation that the layers that enclose the electro-optical material, i.e., the further substrate and the stratified polymer layer, can be kept thin enough to enable switching of the electro-optical material through said layers. The further substrate may be a polymer layer, in which case a very flexible electro-optical stack can be formed, or a thin glass substrate. The addition of the adhesive layer, which may be a pressure-sensitive adhesive, to the optical stack means that the optical stack can be produced in a separate process, and added to the backplane comprising switching means for switching the electro-optical material between a first state and a second state after completion of the optical stack, thus protecting the switching means, e.g., the organic semiconductor materials, on the backplane from exposure to harmful components used in the formation of the optical stack.

Apart from the protection of any sensitive components on the backplane, the method of the present invention has an additional advantage. A problem with building an optical stack on top of a backplane is that a failure in one of the processing steps of the optical stack leads to the loss of a complete electronic device. However, by producing the optical stack separately, the yield of the production of the electronic device that is to be formed by combining the optical stack and the backplane is improved, because faults in the optical stack production no longer cause the loss of the whole electronic device.

There are a number of ways of adhering the electro-optical stack to the substrate. The step of adhering the substrate to the stratified electro-optical stack can be preceded by providing the substrate with an adhesive layer.

Alternatively, the step of adhering the substrate to the stratified electro-optical stack is preceded by providing the stratified electro-optical stack with an adhesive layer.

Preferably, the step of providing the stratified electro-optical stack with an adhesive layer comprises providing the stratified electro-optical stack with an adhesive planarization layer over the polymer layer. This has the advantage that no separate planarization layer is required, which reduces the thickness of the electro-optical stack, and facilitates the switching of the electro-optical material.

Another advantageous way of adhering the electro-optical stack to the substrate is by adding a material to the mixture of an electro-optical material and a polymer precursor that enlarges the adhesive properties of the resulting polymer layer covering the electro-optical material on the further substrate. Consequently, the optical stack can be kept even thinner, further facilitating the switching of the electro-optical material.

In a further advantageous embodiment, the method comprises the step of providing the further substrate comprising of a polymer support covered by a light-sensitive release lacquer prior to the step of depositing a mixture of a electro-optical material and a polymer precursor on the further substrate; and releasing the polymer support by providing a light stimulus to the light-sensitive release lacquer after adhering the substrate to the stratified electro-optical stack. This has the advantage that the electro-optical stack can be kept very thin, which improves the flexibility of the electro-optical stack and reduces parallax effects.

Advantageously, the method further comprises the step of covering the photosensitive release lacquer with a barrier layer prior to the step of depositing a mixture of an electro-optical material and a polymer precursor on the further substrate, to improve the structural robustness of the further substrate after the removal of the polymer support.

In a further embodiment, the method further comprises the step of providing the further substrate with a conductive layer prior to the step of depositing a mixture of an electro-optical material and a polymer precursor on the further substrate. This has the advantage that the conductive layer can be used as a common electrode, thus facilitating the switching of the electro-optical material.

In case of the electro-optical material being a liquid crystal material, the method may further comprise steps to provide the electro-optical stack with an alignment layer and light-polarizing layers e.g. coatable polarizers from Optiva Inc. Alternatively, one of the light polarizing layers may be deposited over the substrate. As a further alternative, rather than providing light-polarizing layers, the adhered arrangement of the substrate and the electro-optical stack may be sandwiched between conventional polarizers, thus reducing the distance between the electrodes which facilitates the switching of the liquid crystal material.

According to a further aspect of the invention, there is provided an electronic device comprising a substrate carrying an electrode structure; an electro-optical stack at least partially covering the electrode structure, the electro-optical stack comprising a stratified polymer layer, a further substrate and an electro-optical material sandwiched between the polymer layer and the further substrate; and an adhesive layer between the substrate and the electro-optical stack.

Such an electronic device can be formed by executing the steps of the method of the present invention. It is emphasized that the aforementioned various advantageous embodiments of said method could be used to produce analogous advantageous embodiments of the electronic device of the present invention.

An additional advantage is obtained if the further substrate comprises a colour filter plate. This obviates the need for the additional of a separate colour filter plate for a colour display type electronic device, which reduced the thickness of the electronic device and increases its flexibility, especially when the substrate is a polymer material.

The invention is described in more detail and by way of nonlimiting examples with reference to the accompanying drawings, wherein:

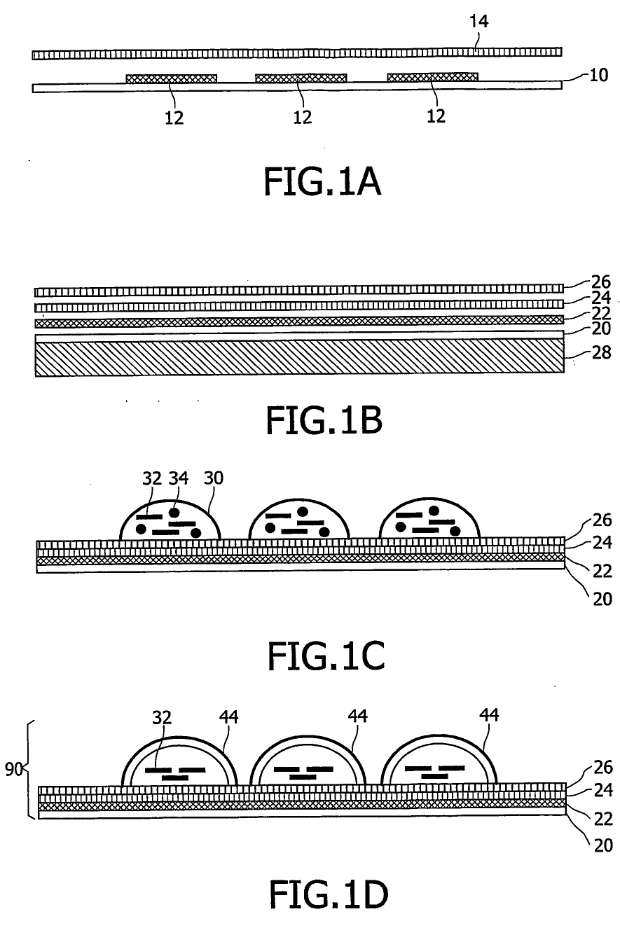

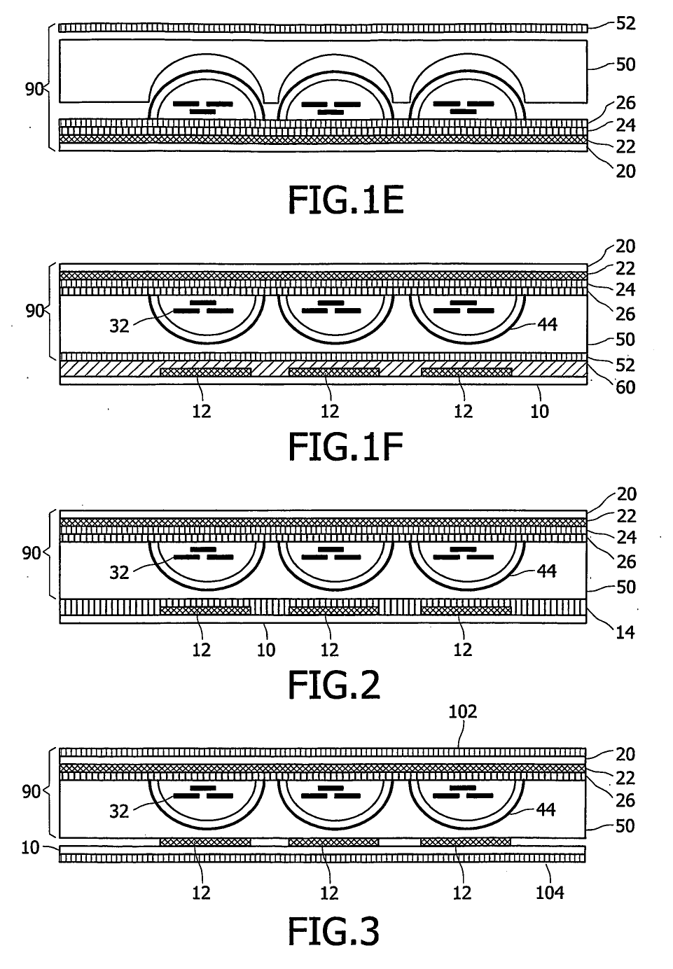

FIG. 1 depicts an embodiment of the method and an electronic device of the present invention;

FIG. 2 depicts another embodiment of an electronic device of the present invention; and

FIG. 3 depicts yet another embodiment of an electronic device of the present invention.

It should be understood that the Figures are merely schematic and are not drawn to scale. It should also be understood that the same reference numerals are used throughout the Figures to indicate the same or similar parts.

In FIG. 1a, a substrate 10 with an electrode structure 12 is provided. The substrate 10 may be a glass substrate, a polymer substrate like a polymer film or a silicon based substrate. In the context of the present invention, the electrode structure 12 should be interpreted to include an interdigitated electrode structure, a passive matrix structure as well as an active matrix structure. It is well known to a person skilled in the art how such an electrode structure 12 can be applied to a substrate 10, and this will therefore not be further explained. It is emphasized that the present invention is particularly advantageous to a plastic substrate 10 carrying an electrode structure 12 in the form of an active matrix including organic materials such as thin film transistors including an organic semiconductor layer, since these materials are particularly sensitive to further processing steps on top of the electrode structure 12. The electrode structure 12 may be covered with a light polarizing layer 14, which will be detailed in more detail further down.

In a separate step, an electro-optical stack 90 is formed. The initial step is shown in FIG. 1b. A further substrate 20 is provided, which may be a thin glass substrate or a thin polymer film. Alternatively, if the electronic device to be produced is a colour display device, the further substrate 20 may be a colour filter plate, which has the advantage that structural rigidity of the colour filter plate is utilized as a support for the electro-optical stack to be formed. Obviously, a colour filter plate can be provided in addition to the further substrate 20 without departing from the teachings of the present invention.

If a very thin electro-optical stack is desirable, for instance in applications where parallax effects should be kept to a minimum, the further substrate 20 may comprise a light-sensitive release lacquer such as a UV-sensitive release lacquer. Typically, the release lacquer is adhered to a polymer support 28, which should give this embodiment of the further substrate 20 the required structural rigidity to enable the further processing steps in the formation of the electro-optical stack. Since the polymer support 28 is going to be removed, the thickness of the polymer support 28 can be chosen to optimize the structural rigidity of the further substrate 20 for the production of the electro-optical stack 90. Upon completion of the production of the electro-optical stack 90, the light-sensitive release lacquer is exposed to light with an appropriate wavelength, after which the polymer support 28 is removed from the electro-optical stack. The further substrate 20 may further comprise a barrier layer (not shown) such as a polymer or a sol-gel to improve the mechanical robustness of the further substrate 20 and/or the resistivity of the electronic device 100 to be formed against water and/or oxygen after removal of the polymer support 28.

Optionally, a conductive layer 22, such as an indium tin oxide (ITO) layer, may be deposited over the further substrate 20, which can act as a common electrode in the electronic device 100 to be formed. Deposition of an ITO layer prior to the formation of the electro-optical layer is advantageous, because the ITO layer is typically formed at temperatures that may be detrimental to the electro-optical layer. Therefore, the method of the present invention is particularly advantageous to electronic devices that require a top-bottom electrode structures. In the case of the electro-optical stack 90 including a liquid crystal material, a light-polarizing layer 24 may be deposited by known techniques such as doctor blading or slot-die coating, and a orientation layer 26 may be deposited by known techniques such as spin coating or flexo printing, over the further substrate 20.

In a next step, a mixture of an electro-optical material 32 and a polymer precursor 34 is deposited over the further substrate 20. This may for instance be realized by a doctor blading technique as disclosed in European patent application EP1065553, or by a printing technique as described in the non-prepublished UK patent application UK 0319908.0 and shown in FIG. 1c, in which the mixture is deposited in the form of separate droplets.

Subsequently, the mixture is exposed to an appropriate stimulus such as UV light to initiate a polymerization reaction in which the polymer precursor 34 is phase-separated from the mixture and a (distributed) stratified polymer layer 44 is formed, as shown in FIG. 1d, leading to the electro-optical material 32 being sandwiched between the stratified polymer layer 44 and the further substrate 20.

A non-limiting example of the mixture of the electro-optical material and the polymer precursor to be deposited on the further substrate is as follows:

50 weight percent (wt %) of a liquid crystal mixture, for instance the mixture E7, which is marketed by Merck, the liquid crystal mixture being an embodiment of the electro-optical material 32;

45 wt % photo-polymerizable isobornylmethacrylate (supplied by Sartomer);

4.5 wt % of a stilbene dimethacrylate dye:

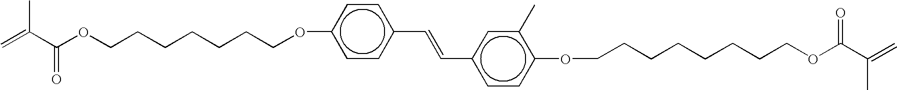

the synthesis of which has been disclosed in PCT patent application WO 02/42382 and which is hereby incorporated by reference, the two acrylates being an embodiment of the polymer precursor 34; and

0.5 wt % benzildimethylketal, which is marketed by Ciba-Geigy under the trade name Irgacure 651.

A non-limiting example of the printing process described in the non-prepublished UK patent application UK 0319908.0 is as follows. In a test setup, a 6×6 inch square glass carrier as an embodiment of the further substrate 20 was provided with a rubbed polyimide alignment layer Al3046 from the JSR electronics Company of Japan. The dimensions of the further substrate 20 were chosen to fit 9 small displays. It is emphasized that much larger dimensions are equally feasible, however, and that the printing process can also be carried out on other embodiments of the further substrate 20, e.g., a polymer film or a light-sensitive release lacquer on top of a polymer substrate. The further substrate was mounted on a computer controlled X-Y table having a variable speed of 1-30 mm/s.

A MicroDrop inkjet printing device was placed in a fixed position over the X-Y table. The dispensing head of the MicroDrop inkjet printing device included a glass capillary shaped into a nozzle on one side, the capillary being surrounded by a tubular piezo-activator for generating a pressure wave through the capillary. The pressure wave triggers the release of a droplet of the first liquid from the capillary. The droplets were exposed to UV light from a Philips TL08 UV lamp with a light intensity of 0.1 mW/cm² for 30 minutes at 40° C., after which the formation of the electro-optical elements was completed. In case of using a light-sensitive release lacquer that is sensitive in the UV region of the electromagnetic spectrum, care has to be taken that the release lacquer is not activated by the low concentrations of UV light used to form the stratified polymer layer of the electro-optical stack.

The inclusion of a compound having a chromophore strongly absorbing in the UV region of the electromagnetic spectrum, i.e., the stilbene dimethacrylate dye in the example above, causes a gradient in the UV intensity through the deposited droplets. Consequently, the polymerization reaction predominantly takes place at the surface of the droplets facing the UV source.

If the stratified polymer layer 44, which may be a distributed stratified polymer layer 44 resulting from the above described printing process, is not flat enough, a planarization layer 50 such as an polymerizable acrylate layer may be coated over the stratified polymer layer 44 to allow further processing of the electro-optical stack 90, as shown in FIG. 1e. Such further processing may include the deposition of a further light-polarizing layer 52 in case of the electro-optical material 32 being a liquid crystal material.

Upon completion of the electro-optical stack 90, the electronic device 100 is formed by adhering the electro-optical stack to the substrate 10, for instance by means of an adhesive layer 60, as shown in FIG. 1f. The adhesive layer 60 may have been applied over planarization layer 50 or over the second light-polarizing layer 52, if present. Alternatively, the adhesive layer may have been applied over the surface of the substrate 10 including the electrode structure 12. The adhesive layer may comprise a pressure-sensitive adhesive such as a tacky polybutylacrylate, or an adhesive based on thermosetting epoxides, photosetting acrylates, anaerobic cyanoacrylates or other known adhesive compounds.

It is emphasized that the adhesive layer 60 should be kept as thin as possible, to minimize the required voltages to be supplied by the electrode structure 12 in possible conjunction with the conductive layer 22 to switch the electro-optical material 32. Also, care has to be taken that the adhesive layer 60 does not undergo an unwanted chemical reaction with the contact layers of the electronic device 100, since this may lead to a degradation of the performance of the electronic device 100.

At this point, it is emphasized that the use of a dedicated adhesive layer 60 is not strictly necessary. For instance, the stratified polymer layer 44 can be made adhesive by the addition of an adhesive compound to the mixture of the electro-optical material and the polymer precursor, such as n-propylacrylate, which is a pressure-sensitive adhesive. The polymerization process described above will lead to a concentration gradient of the n-propylacrylate through the stratified polymer layer 44, with the highest concentration of the n-propylacrylate at the outer surface of the stratified polymer layer 44. It will be appreciated by those skilled in the art that this is particularly advantageous if a regular, flat stratified polymer layer 44 extending over the majority of the surface of the further substrate 20 can be formed, because such a flat surface is a prerequisite to get a strong adhesive interaction between the electro-optical stack and the substrate 10. Obviously, no further processing over the stratified polymer layer 44 is possible in this embodiment. However, if further additional layers are required, these may be deposited over the substrate 10, such as the optional light-polarizing layer 14 shown in FIG. 1a. Consequently, a very thin electronic device 100 can be obtained, which is particularly advantageous when the substrate 10 and the further substrate 20 are polymer based, which will yield a very flexible electronic device 100.

An alternative embodiment of an electronic device 100 lacking a dedicated adhesive layer 60 is shown in FIG. 2. The electronic device 100 in FIG. 2 is formed by using the planarization layer 50 as an adhesive. An adhesive planarization layer 50 may be formed by depositing an acrylate layer over the (distributed) polymer layer 44 and polymerize the acrylate until a sticky planarization layer 50 is obtained. The sticky planarization layer 50 is adhered to the substrate 10 after which the polymerization reaction of: the acrylate is completed. Obviously, in the case of the electro-optical stack 90 comprising liquid crystal materials, the required light-polarizing layer 14 may be applied to the substrate 10 prior to the adhesion of the planarization layer 50 to the substrate 10.

Alternatively, as shown in FIG. 3, the light-polarizing layers 14 and 24 may be omitted from the substrate 10 and the further substrate 20 and replaced by traditional polarizers 102 and 104 sandwiched around the electronic device 100.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of producing an electronic device (100) having a stratified electro-optical stack (90) on a substrate (10) carrying an electrode structure (12), the method comprising the steps of:
providing the substrate (10) carrying the electrode structure (12);
providing a further substrate (20);
depositing a mixture of an electro-optical material (32) and a polymer precursor (34) on the further substrate (20);
forming the stratified electro-optical stack (90) by polymerizing the polymer precursor (34) into a polymer layer (44) sandwiching the electro-optical material (32) between the polymer layer (44) and the further substrate (20); and
adhering the substrate (10) to the stratified electro-optical stack (90).

2. A method as claimed in claim 1, wherein the step of adhering the substrate (10) to the stratified electro-optical stack (90) is preceded by providing the substrate (10) with an adhesive layer (60).

3. A method as claimed in claim 1, wherein the step of adhering the substrate (10) to the stratified electro-optical stack (90) is preceded by providing the stratified electro-optical stack (90) with an adhesive layer (44, 50, 60).

4. A method as claimed in claim 3, wherein the step of providing the stratified electro-optical stack (90) with an adhesive layer (50) comprises providing the stratified electro-optical stack (90) with an adhesive planarization layer (50) over the polymer layer (44).

5. A method as claimed in claim 2, further comprising the steps of:
providing the further substrate (20) comprising a polymer support (28) covered by a light-sensitive release lacquer prior to the step of depositing a mixture of a electro-optical material (32) and a polymer precursor (34) on the further substrate (20); and
releasing the polymer support (28) by providing a light stimulus to the light-sensitive release lacquer after adhering the substrate (10) to the stratified electro-optical stack (90).

6. A method as claimed in claim 5, further comprising the step of covering the photosensitive release lacquer with a barrier layer prior to the step of depositing a mixture of an electro-optical material (32) and a polymer precursor (34) on the further substrate (20).

7. A method as claimed in claim 1, further comprising the step of providing the further substrate (20) with a conductive layer (22) prior to the step of depositing a mixture of an electro-optical material (32) and a polymer precursor (34) on the further substrate (20).

8. A method as claimed in claim 1, further comprising the step of adding an adhesive to the mixture of an electro-optical material (32) and a polymer precursor (34) prior to the step of depositing the mixture on the further substrate.

9. A method as claimed in claim 1, wherein the electro-optical material (32) is a liquid crystal material, the method further comprising the step of providing the further substrate with an alignment layer (26) prior to the step of depositing a mixture of an electro-optical material (32) and a polymer precursor (34) on the further substrate.

10. A method as claimed in claim 9, further comprising the step of providing the substrate (10) with a light-polarizing layer (14).

11. A method as claimed in claim 2, further comprising the step of activating the adhesive layer (60) by means of pressure.

12. An electronic device (100) comprising:
a substrate (10) carrying an electrode structure (12);
an electro-optical stack (90) at least partially covering the electrode structure (12), the electro-optical stack (90) comprising a stratified polymer layer (44), a further substrate (20) and an electro-optical material (32) sandwiched between the polymer layer (44) and the further substrate (20); and
an adhesive layer (44, 50, 60) between the substrate (10) and the electro-optical stack (90).

13. An electronic device (100) as claimed in claim 12, wherein the polymer layer (44) comprises the adhesive layer.

14. An electronic device (100) as claimed in claim 13, wherein the adhesive layer (50, 60) is oriented between the polymer layer (44) and the substrate (10).

15. An electronic device (100) as claimed in claim 14, wherein the adhesive layer is a planarization layer (50).

16. An electronic device (100) as claimed in claim 12, wherein the electro-optical material (32) comprises a liquid crystal material, the electronic device (100) further comprising:
an alignment layer (26) between the electro-optical material (32) and the further substrate (20);
a first light-polarizing layer (14) between the electro-optical material (32) and the substrate (10); and
a second light-polarizing layer (24) between the alignment layer (26) and the further substrate (20).

17. An electronic device (100) as claimed in claim 12, wherein the electro-optical material (32) comprises a liquid crystal material, the electronic device (100) further comprising:
an alignment layer (26) between the electro-optical material (32) and the further substrate (20); and
a first polarizer (102) and a second polarizer (104), the substrate (10) and the electro-optical stack (90) being oriented between the first polarizer (102) and the second polarizer (104).

18. An electronic device (100) as claimed in claim 12, wherein the further substrate (20) comprises a colour filter plate.

19. An electronic device (100) as claimed in claim 12, the electronic device (100) further comprising a conductive layer (22) between the further substrate (20) and the electro-optical material (32).

20. An electronic device (100) as claimed in claim 12, wherein the further substrate (20) comprises a plastic substrate.

21. An electronic device as claimed in claim 12, wherein the further substrate (20) comprises a glass substrate.

22. An electronic device as claimed in claim 12, wherein the further substrate (20) comprises a light-sensitive release lacquer.
